(19) United States
(12) Patent Application Publication
(10) Pub. No.: US 2018/0288629 A1
(43) Pub. Date: Oct. 4, 2018

(54) SYSTEM AND METHOD FOR DETERMINING AN IDEAL CONFIGURATION OF A NETWORK

(71) Applicant: Rohde & Schwarz GmbH & Co. KG, Munich (DE)

(72) Inventors: Hanush KHURANA, SINGAPORE (SG); Prabhakaran EKAMBARAM, SINGAPORE (SG)

(21) Appl. No.: 15/474,681

(22) Filed: Mar. 30, 2017

(51) Int. Cl. H04W 24/02; H04W 24/06; H04L 12/26

(52) U.S. Cl. CPC H04W 24/02; H04L 43/18; H04W 24/06

(57) ABSTRACT

A system for determining an ideal configuration of a network, wherein the system comprises a network configuration device comprising a network simulation means providing a simulated network, and an analyzer means capturing data traffic. The analyzer means further comprises a calculation means. The simulation means is connected to the analyzer means, and the simulation means is connected to a device under test.

### TECHNICAL FIELD

The invention relates to a system and a method for determining an ideal configuration of a network especially on the basis of the behavior of a simulated network.

### BACKGROUND

Generally, in times of a steadily growing volume of data to be exchanged and an increasing number of networks, there is a growing need of a system and a method for determining an ideal network configuration in a most efficient manner in order to allow for a highly performant and low-cost network.

U.S. Pat. No. 6,631,128 B1 relates to the management of communications networks and, in particular, to the optimization of topology and technology types within a network to support certain traffic types. Disadvantageously, the core network optimization according to said document is not based on a simulated network, which results in high costs because network optimizations have to take place in the field, which leads to the disadvantage that a longer time is required for implementing the network.

Accordingly, there is a need for an approach for determining an ideal configuration of a network on the basis of the behavior of a simulated network.

### Some Example Embodiments

Embodiments of the present invention advantageously address the foregoing requirements and needs, as well as others, by providing a system and a method for determining an ideal configuration of a network on the basis of the behavior of a simulated network.

According to a first aspect of example embodiments of the present invention, a system for determining an ideal configuration of a network is provided. The system comprises a network simulation means, wherein the network simulation means provides a simulated network, and a device under test, wherein the device under test is connected to the simulated network, and wherein the ideal configuration of the network is determined based on the behavior of the simulated network.

According to a first implementation form of the first aspect, the device under test is a wireless communication device.

According to a further implementation form of the first aspect, the system further comprises an analyzer means, wherein the analyzer means is connected to the network simulation means for capturing data traffic.

According to a further implementation form of the first aspect, the analyzer means comprises a calculation means for determining the ideal network configuration based on the data traffic.

According to a further implementation form of the first aspect, the analyzer means determines an inactivity timer of the network based on the data traffic.

According to a further implementation form of the first aspect, the inactivity timer is a discontinuous reception inactivity timer or a short discontinuous reception cycle timer or a discontinuous reception short cycle timer or a long discontinuous reception cycle timer or a discontinuous reception retransmission timer or an on-duration timer or a discontinuous reception cycle timer.

According to a further implementation form of the first aspect, the data of the network comprises payload and signaling data.

According to a further implementation form of the first aspect, the device under test comprises a defined set of applications.

According to a further implementation form of the first aspect, at least one application of the defined set of applications of the device under test comprises over-the-top data traffic.

According to a further implementation form of the first aspect, the analyzer means identifies a single application or a set of applications of the device under test.

According to a second aspect of example embodiments of the present invention, a method for determining an ideal configuration of a network is provided. The method comprises the steps of providing a simulated network, and determining the ideal configuration of the network based on the behavior of the simulated network.

According to a first implementation form of the second aspect, the method further comprises the step of capturing data traffic.

According to a further implementation of the second aspect, the ideal network configuration is calculated based on the data traffic.

According to a further implementation of the second aspect, the method further comprises the step of determining an inactivity timer of the network based on the data traffic.

According to a further implementation of the second aspect, the inactivity timer is a discontinuous reception inactivity timer or a short discontinuous reception cycle timer or a discontinuous reception short cycle timer or a long discontinuous reception cycle timer or a discontinuous reception retransmission timer or an on-duration timer or a discontinuous reception cycle timer.

According to a further implementation of the second aspect, the data of the network comprises payload and signaling data.

According to a further implementation of the second aspect, the method further comprises the step of connecting a device under test to the simulated network, wherein the device under test comprises a defined set of applications, wherein at least one application of the set of applications of the device under test comprises over-the-top data traffic.

According to a third aspect of the invention, a computer program with program code means for performing all steps according to the second aspect, if the program is executed on a computer device or digital signal processor, is provided.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

Embodiments of the present invention are illustrated by way of example, and not by way of limitation, in the figures of the accompanying drawings, in which like reference numerals refer to similar elements, and in which:

FIG. 1 shows a block diagram of a system for determining an ideal configuration of a network, in accordance with example embodiments; and

FIG. 2 shows a flow chart of a method for determining an ideal configuration of a network, in accordance with example embodiments.

### DETAILED DESCRIPTION

A system and a method for determining an ideal configuration of a network on the basis of the behavior of a simulated network are described. In the following description, for the purposes of explanation, numerous specific details are set forth in order to provide a thorough understanding of the invention. It is apparent, however, that the invention may be practiced without these specific details or with an equivalent arrangement. In other instances, well-known structures and devices are shown in block diagram form in order to avoid unnecessarily obscuring the invention.

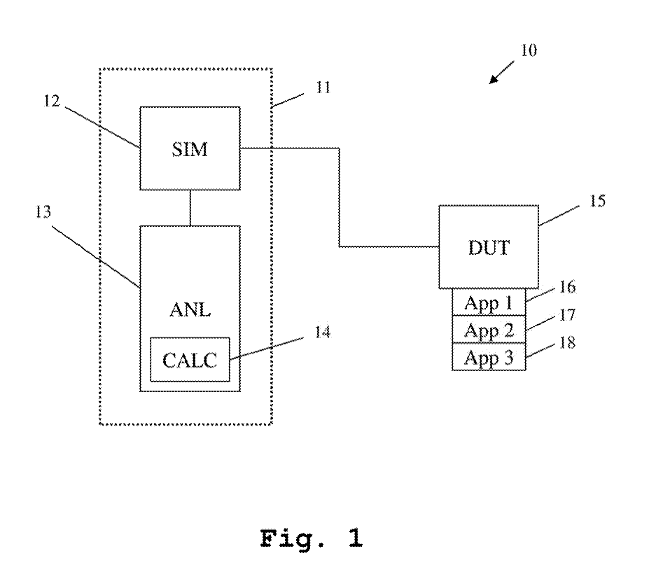

FIG. 1 illustrates an example of a system 10 for determining an ideal configuration of a network, in accordance with example embodiments of the present invention.

According to FIG. 1, a network configuration device 11 comprising a network simulation means 12 and an analyzer means 13 is shown. In addition to this, said analyzer means 13 comprises a calculation means 14, and said simulation means 12 is connected to said analyzer means 13. Furthermore, the simulation means 12 is also connected to a device under test 15.

The network simulation means 12 provides a simulated network, to which the device under test 15 (e.g., a wireless communication device) is connected. Additionally, the ideal configuration of the network is determined based on the behavior of the simulated network provided by the network simulation means 12.

Moreover, with the aid of the analyzer means 13 and the connection between the simulation means 12 and the analyzer means 13, the data traffic is captured.

Advantageously, the calculation means 14 is configured to determine the ideal network configuration based on the data traffic.

Further advantageously, the analyzer means 13 determines an inactivity timer of the network based on the data traffic. By way of example, the inactivity timer may be a discontinuous reception (DRX) inactivity timer or a short DRX cycle timer or a DRX short cycle timer or a long DRX cycle timer or a DRX retransmission timer or an on-duration timer or a DRX cycle timer.

In addition to this, the inactivity timer may be comprised by a base station of the network. Advantageously, with the aid of the optimal configuration of the inactivity timer, energy can be saved and resources of the network are used in an efficient manner.

Furthermore, also with respect to the network, data of the network may comprise both payload and signaling data.

At this point, as it can be seen, the system 10 for determining the ideal configuration of the network provides the benefit that the optimal configuration of a network can be found in a laboratory environment without the need of expensive network configuration tests done in live networks. As a result, time and costs are significantly reduced.

Moreover, with respect to the device under test 15, the device under test 15 may comprise a defined set of applications (e.g., the three different applications 16, 17, and 18, as shown in FIG. 1). In addition to this, at least one application of the defined set of applications of the device under test 15 may comprise over-the-top (OTT) data traffic. Consequently, effects of such applications (such as an application of the device under test 15 comprising OTT data traffic) on the network can advantageously be investigated.

In this context, the analyzer means 13 can advantageously identify a single application ora set of applications of the device under test 15.

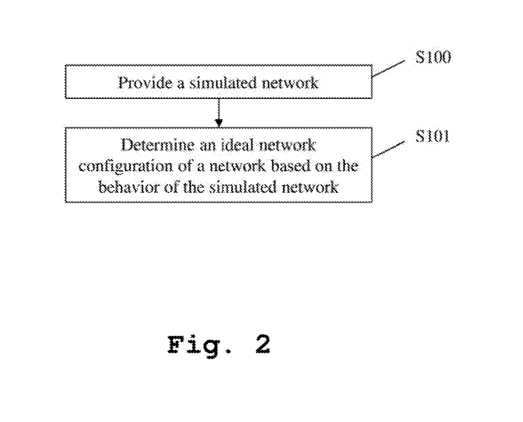

FIG. 2 shows a flow chart of a method for determining an ideal configuration of a network, in accordance with example embodiments of the present invention. In a first step S100, a simulated network is provided. Then, in a second step S101, the ideal configuration of a network is determined based on the behavior of the simulated network.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A system for determining an ideal configuration of a network, the system comprising:
a device under test;
a network simulator configured to generate a simulated network, and to provide the simulated network to the device under test; and
a network analyzer connected to the network simulator, wherein the network analyzer is configured to capture data traffic via the connection to the network simulator, and to identify a single application or a set of applications of the device under test; and
wherein the ideal configuration of the network is thereby determined based on behavior of the simulated network.

2. The system according to claim 1, wherein the device under test is a wireless communication device.

3. (canceled)

4. The system according to claim 3, wherein the network analyzer comprises a calculation device configured to determine the ideal network configuration based on the data traffic.

5. The system according to claim 3, wherein the network analyzer determines an inactivity timer of the network based on the data traffic.

6. The system according to claim 5, wherein the inactivity timer is one of a discontinuous reception inactivity timer, a short discontinuous reception cycle timer, a discontinuous reception short cycle timer, a long discontinuous reception cycle timer, a discontinuous reception retransmission timer, an on-duration timer, and a discontinuous reception cycle timer.

7. The system according to claim 1, wherein data of the network comprise payload and signaling data.

8. The system according to claim 1, wherein the device under test comprises a defined set of applications.

9. The system according to claim 8, wherein at least one application of the defined set of applications of the device under test comprises over-the-top data traffic.

10. (canceled)

11. A method for determining an ideal configuration of a network, the method comprising:
generating, by a network simulator, a simulated network, and providing the simulated network to a device under test;
capturing, by a network analyzer connected to the network simulator, data traffic via the connection to the network simulator; and
identifying, by the network analyzer, a single application or a set of applications of the device under test; and
wherein the ideal configuration of the network is thereby determined based on behavior of the simulated network.

12. (canceled)

13. The method according to claim 11, wherein the ideal network configuration is calculated based on the data traffic.

14. The method according to claim 11, further comprising:
determining, by the network analyzer, an inactivity timer of the network based on the data traffic.

15. The method according to claim 14, wherein the inactivity timer is one of a discontinuous reception inactivity timer, a short discontinuous reception cycle timer, a discontinuous reception short cycle timer, a long discontinuous reception cycle timer, a discontinuous reception retransmission timer, an on-duration timer and a discontinuous reception cycle timer.

16. The method according to claim 11, wherein data of the network comprise payload and signaling data.

17. The method according to claim 11, wherein the device under test comprises a defined set of applications, wherein at least one application of the set of applications of the device under test comprises over-the-top data traffic.

18. A non-transitory computer-readable storage medium including one or more sequences of program code, where, when the program code is executed on one or more processors of a device, the device is caused to perform a process for determining an ideal configuration of a network comprising steps of:
generating a simulated network, and providing the simulated network to a device under test;
capturing data traffic of the simulated network; and
identifying a single application or a set of applications of the device under test; and
wherein the ideal configuration of the network is thereby determined based on behavior of the simulated network.
